(19) United States
(12) Patent Application Publication
(10) Pub. No.: US 2023/0279530 A1
(43) Pub. Date: Sep. 7, 2023

(54) PARAMAGNETIC HARD STAINLESS STEEL AND METHOD FOR MANUFACTURING SAME

(71) Applicant: The Swatch Group Research and Development Ltd, Marin (CH)

(72) Inventor: Joël PORRET, Marin-Epagnier (CH)

(73) Assignee: The Swatch Group Research and Development Ltd, Marin (CH)

(21) Appl. No.: 18/043,837

(22) PCT Filed: Sep. 6, 2021
(86) PCT No.: PCT/EP2021/074505

§ 371 Date: Mar. 2, 2023

(30) Foreign Application Priority Data
Nov. 9, 2020 (EP) 20206523.1

(51) Int. Cl. C22C 38/50; B22F 10/64; B33Y 40/20; B33Y 70/00; C21D 9/00; C21D 6/00; C21D 1/18; C22C 38/48; C22C 38/44; C22C 38/42; C22C 38/06; C22C 38/04; C22C 38/02; C22C 38/00

(52) U.S. Cl. CPC C22C 38/50; B22F 10/64; B33Y 40/20; B33Y 70/00; C21D 9/0068; C21D 6/004; C21D 1/18; C22C 38/48; C22C 38/44; C22C 38/42; C22C 38/06; C22C 38/04; C22C 38/02; C22C 38/002; C22C 38/001; C21D 2211/001; C21D 2211/005; B22F 10/28

(57) ABSTRACT

A paramagnetic stainless steel with a chemical composition may include iron and, by weight: 20≤Cr≤40%; 3≤Ni≤20%; 0≤Mn≤15%; 0≤Al≤5%; 3≤Mo≤15%; 0≤W≤5%; 0≤Cu≤2%; 0≤Si≤5%; 0≤Ti≤1%; 0≤Nb≤1%; 0≤C≤0.1%; 0≤N≤0.5%; 0≤S≤0.5%; 0≤P≤0.1%, and optionally impurities, each at a concentration of less than or equal to 0.5%. The steel may have a hardness in a range of from 575 to 900 HV10. A part, in particular a timepiece component, may be made from or include this steel.

### FIELD OF THE INVENTION

The invention relates to a paramagnetic stainless steel having a hardness of greater than or equal to 575 HV and to the part, in particular a timepiece component, made of this steel. It further relates to the method for manufacturing this stainless steel part.

### BACKGROUND OF THE INVENTION

Hard, non-ferromagnetic metal alloys are used in many fields, essentially for components that are subject to high mechanical and/or tribological stress and must remain insensitive to magnetic fields. This is in particular the case for numerous timepiece components such as wheels, pinions, shafts or springs in the movement. Obtaining high hardnesses is also of interest for external parts, for example for the middle, the bezel, the back or the crown. This is because a high hardness generally procures better scratch and wear resistance and thus a good durability of these components which are exposed to the external environment.

In metallurgy, various mechanisms are used to harden alloys, according to the chemical compositions and thermomechanical histories thereof. Solid solution hardening, age hardening, strain hardening, martensitic transformation in steels, spinodal decomposition, or grain boundary strengthening (Hall Petch) are known in this respect. The most noteworthy alloys benefit from several of these hardening mechanisms simultaneously. However, non-ferromagnetic alloys with hardnesses of greater than 500 HV are rare. Furthermore, to achieve such a high level of hardness, crystalline non-ferromagnetic alloys typically require a high degree of strain hardening, prior to an optional heat treatment to achieve maximum hardness by precipitation of second phases. This is the case, for example, with austenitic stainless steels, which can only be hardened by strain hardening, or with some austenitic superalloys, which can be hardened by strain hardening followed by a precipitation heat treatment. In practice, components are difficult to manufacture from these alloys in the strain-hardened temper. Firstly, in the case of forging, obtaining the right degree of strain hardening to obtain the required hardness is not simple, especially for parts with a complex geometry. Alternatively, machining can be carried out in semi-finished products having a defined and homogeneous degree of strain hardening, but it is not always easy to obtain the right material formats with the required degree of strain hardening. Furthermore, any machining operations are very difficult and costly, as the alloy is already at least partially hardened. Finally, if the method used does not involve plastic deformation, like some powder metallurgy or additive manufacturing methods, it is simply not possible to harden these alloys. Alternatively, alloys with an intrinsic hardness of greater than 500 HV could be manufactured, such as certain high-entropy alloys or intermetallic alloys for example, but these would again be very difficult to machine and almost impossible to deform, due to the very high hardnesses and very low ductilities thereof. This highlights the interest in finding an alloy that can be hardened by heat treatment without the need for prior strain hardening, while being non-ferromagnetic in the hardened temper. Forming would thus be carried out in a soft, ductile temper, and a hardening heat treatment would be carried out once the part is finished. This in particular explains the huge success of carbon steels and martensitic stainless steels, but unfortunately the latter are ferromagnetic.

Other solutions are now widely used to obtain hardnesses of greater than 500 HV in non-ferromagnetic alloys. Various surface hardening processes are in particular applied to austenitic stainless steels or titanium alloys, for example, after the parts have been formed. However, the thickness of the hardened layer is typically very small, in the order of a few tens of micrometres, and the surface appearance is typically altered by the treatment. For timepiece components, the parts must thus be reworked after hardening to obtain a clean and overall polished surface. However, these finishing operations remove all or part of the hardened layer and this solution is thus rarely used in practice, especially as surface hardening treatments are generally expensive.

Once again, there is thus a need to find a non-ferromagnetic alloy that can be hardened by heat treatment to achieve a hardness of greater than 500 HV.

### SUMMARY OF THE INVENTION

The aim of the present invention is to overcome the aforementioned drawbacks by proposing a stainless steel composition that has been optimised so as to meet the following criteria:
a paramagnetic behaviour,
a hardness of greater than 500 HV, and more particularly of greater than or equal to 575 HV, by heat treatment without requiring prior strain hardening during the manufacturing process,
very good corrosion resistance.

The part made of this steel must also have a good aesthetic appearance, particularly after polishing.

For this purpose, the stainless steel according to the invention has the following composition by weight:
20≤Cr≤40%,
3≤Ni≤20%,
0≤Mn≤15%,
0≤Al≤5%,
3<MO≤15%,
0≤W≤5%,
0≤Cu≤2%,
0≤Si≤5%,
0≤Ti≤1%,
0≤Nb≤1%,
0≤C≤0.1%,
0≤N≤0.5%,
0≤S≤0.5%,
0≤P≤0.1%,
   the remainder consisting of iron and any impurities, each at a concentration of less than or equal to 0.5%.

According to the invention, the method for manufacturing a stainless steel part consists of carrying out a first heat or thermomechanical treatment on a base material of the aforementioned composition in the ferritic or ferritic-austenitic range and then quenching the material in order to preserve the ferritic or ferritic-austenitic structure at ambient temperature. This ferritic or ferritic-austenitic microstructure is soft and thus ductile, allowing for easy forming where required. Then, after optional forming, a hardening treatment is carried out in order to transform the ferrite into an austenitic phase and into an intermetallic sigma phase.

The novelty of the present invention stems, on the one hand, from the use of the sigma phase as a source of hardening and, on the other hand, from the molybdenum content of over 3% in the composition. More specifically, the sigma phase has always been considered harmful and thus undesired in stainless steels. As the sigma phase is rich in chromium and typically forms at the grain boundaries, it drastically reduces corrosion resistance by reducing the chromium concentration of the other phases present in the alloy. It then embrittles stainless steels very quickly and substantially, even in very small quantities. This is because this phase has a complex tetragonal structure and is intrinsically very brittle and the presence thereof at the grain boundaries creates a favoured path for crack propagation. It has thus never been used in stainless steels, despite its two properties of particular interest, which are its hardness of between 900 and 1,100 HV10 and its paramagnetic nature. According to the invention, the composition of the stainless steel and the method are optimised in order to obtain a fine distribution of both the sigma phase and the austenitic phase without favouring the formation of the sigma phase at the grain boundaries. This particular microstructure, which consists of two non-ferromagnetic phases, provides in particular a very good compromise between hardness and toughness, good corrosion resistance and excellent polishability.

Moreover, the Mo (molybdenum) content of more than 3% improves corrosion resistance. This is because a high Mo content allows a significant Mo concentration to be obtained in the austenite (>1%), even if Mo remains present in a higher concentration in the sigma phase. By increasing the corrosion resistance of the austenite through the presence of Mo, the corrosion resistance of the alloy is improved as a whole, and more specifically the pitting resistance. A second advantage of having a Mo concentration of greater than 3% is that it allows the hardening heat treatment to be carried out in the γ+σ range at a higher temperature, which further increases the Cr (chromium) and Mo concentration in the austenite, thereby further improving corrosion resistance. Furthermore, carrying out the heat treatment at a higher temperature reduces the risk of carbide or nitride formation which reduces corrosion resistance. More specifically, the higher the temperature, the greater the solubility of carbon and nitrogen in the austenite.

Other features and advantages of the present invention will be better understood upon reading the detailed description given below with reference to the following figures.

### BRIEF DESCRIPTION OF THE FIGURES

The diagrams in FIG. 1-5 were generated using the thermodynamic calculation software Thermocalc (TCFE10 database).

FIG. 1 shows a phase diagram of an Fe-(32.5-x)%Cr-7%Ni-x%Mo alloy (mass %) illustrating the effect of Mo on the Sigma+CFC (austenite) phase range.

FIG. 2 shows the effect of the hardening heat treatment temperature on the PREN of the austenite for an Fe-28.5%Cr-7%Ni-4%Mo alloy (mass %).

FIG. 3 shows a phase diagram of an Fe-(29.5-x)%Cr-7%Ni-3%Mo-x%C alloy (mass %) according to the prior art, illustrating the effect of temperature on the solubility of carbon in the austenitic phase.

FIG. 4 shows a phase diagram of an Fe-(27.5-x)%Cr-7%Ni-5%Mo-x%C alloy (mass %) according to the invention, illustrating the effect of temperature on the solubility of carbon in the austenitic phase.

FIG. 5 shows a phase diagram of an Fe-(27.5-x)%Cr-7%Ni-5%Mo-x%N alloy (mass %) according to the invention, illustrating the effect of temperature on the solubility of nitrogen in the austenitic phase.

FIG. 6 shows an image obtained by optical microscopy of an Fe-29.5%Cr-7%Ni-3.5%Mo steel (mass %) according to the invention.

FIG. 7 shows the current-potential curve in a potentiodynamic polarisation test for an Fe-28.5%Cr-7%Ni-4%Mo steel (mass %) according to the invention for three different hardening heat treatment temperatures in comparison with an austenitic stainless steel DIN 1.4435 according to the prior art.

### DESCRIPTION OF THE INVENTION

The invention relates to paramagnetic stainless steels having a hardness of between 575 and 900 HV10, preferably between 650 and 900 HV10, and more preferably between 675 and 900 HV10. HV10 hardness is understood to mean a Vickers hardness measured as per the standard ISO 6507-1:2018. The invention further relates to a part and more specifically to a timepiece component made using this steel. It can be an external component chosen from the non-exhaustive list that includes a middle, a back, a bezel, a crown, a push-piece, a bracelet link, a bracelet, a tongue buckle, a dial, a hand and a dial index. It can also be a component of the movement chosen from the non-exhaustive list that includes a toothed wheel, a shaft, a pinion, a spring, a bridge, a plate, a screw and a balance. The present invention further relates to the method for manufacturing the stainless steel part according to the invention.

The stainless steels according to the invention have the following composition by weight:
20≤Cr≤40%,
3≤Ni≤20%,
0≤Mn≤15%,
0≤Al≤5%,
3≤MO≤15%,
0≤W≤5%,
0≤Cu≤2%,
0≤Si≤5%,
0≤Ti≤1%,
0≤Nb≤1%,
0≤C≤0.1%,
0≤N≤0.5%,
0≤S≤0.5%,
0≤P≤0.1%,
   the remainder consisting of iron and any impurities, each at a concentration of less than or equal to 0.5%.

Preferably, they have the following composition by weight:
25≤Cr≤35%,
5≤Ni≤10%,
0≤Mn≤3%,
0≤Al≤3%,
3<Mo≤10%,
0≤W≤5%,
0≤Cu≤2%,
0≤Si≤3%,
0≤Ti≤1%,
0≤Nb≤1%,
0≤C≤0.1%,
0≤N≤0.5%,
0≤S≤0.5%,
0≤P≤0.1%,
   again with the same remainder consisting of iron and any impurities.

Preferably, the percentage by weight of Mo for one of the aforementioned composition ranges is between 3.5 and 15% or between 3.5 and 10%. More preferably, it is between 3.5 and 6% or between 4 and 6%.

15 Advantageously, the percentage by weight of W for one of the above composition ranges is between 0.2 and 5% and more advantageously between 0.5 and 5%.

The Mo content of greater than 3% by mass allows the concentration of Mo in the austenitic phase to be increased, which in turn leads to an increase in the overall corrosion resistance of the steel.

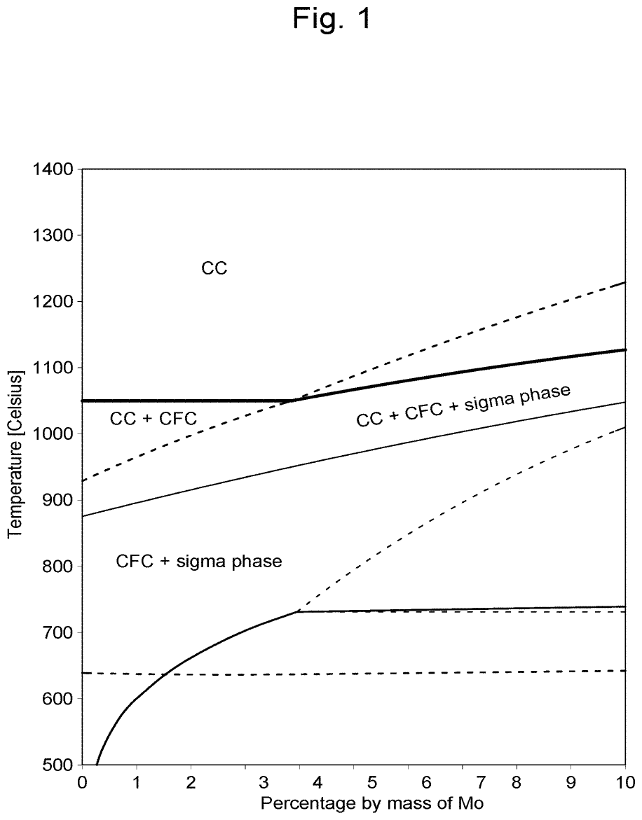

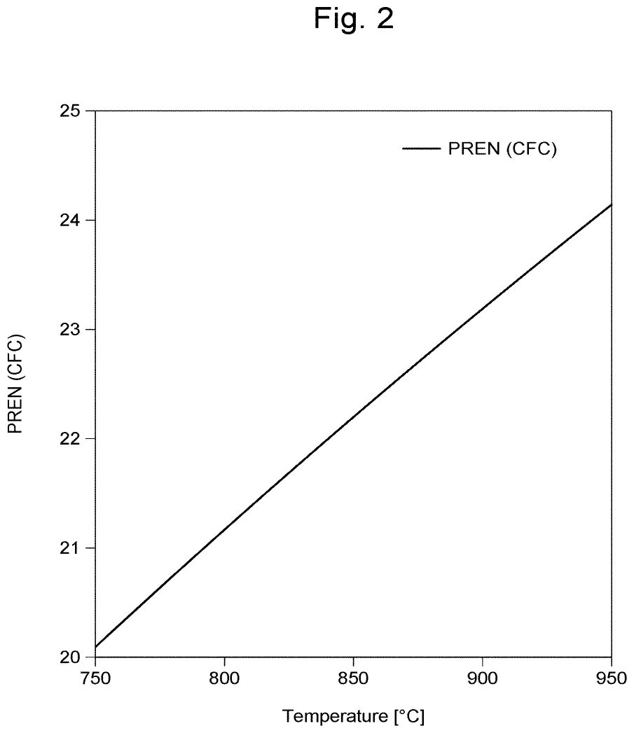

Furthermore, the increase in the Mo concentration above all allows the hardening heat treatment (in the sigma +CFC range) to be carried out at a higher temperature, as shown in FIG. 1. Thus, for 4% Mo, the heat treatment can be carried out up to 950° C., and for 5% Mo, it can be carried out up to 975° C. Carrying out the hardening heat treatment in the sigma +CFC range at a higher temperature further increases the Cr and Mo concentration in the austenite, thereby further improving corrosion resistance. The effect of the treatment temperature on the PREN (Pitting Resistance Equivalent Number based on the Cr, Mo and N content such that PREN=%Cr+3.3×%Mo+16×%N) of the austenite is shown in FIG. 2.

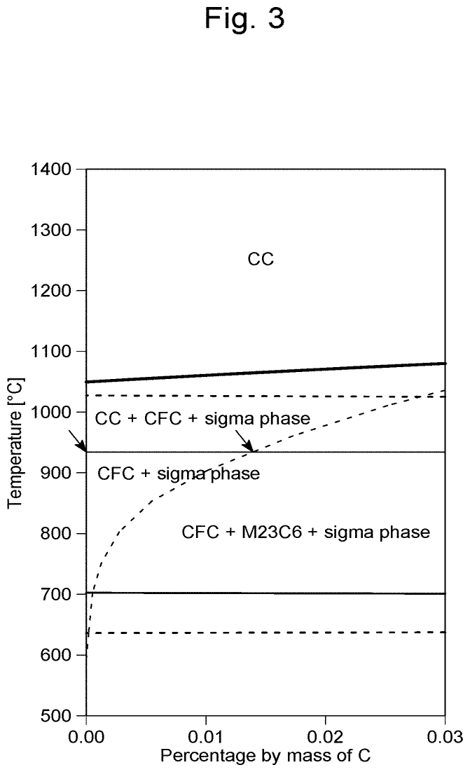

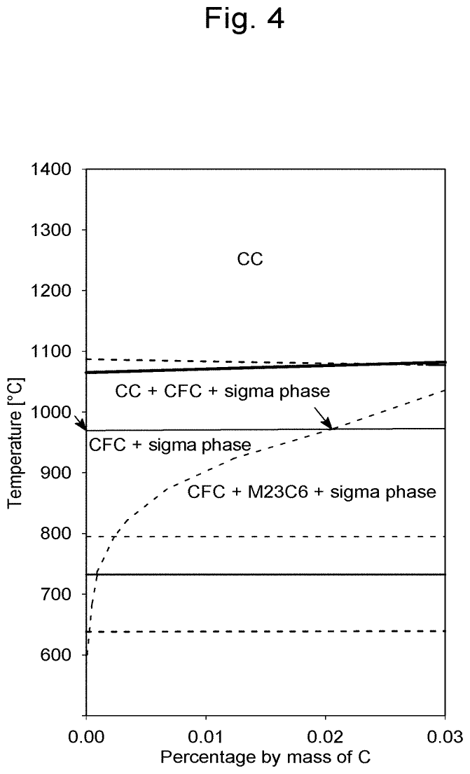

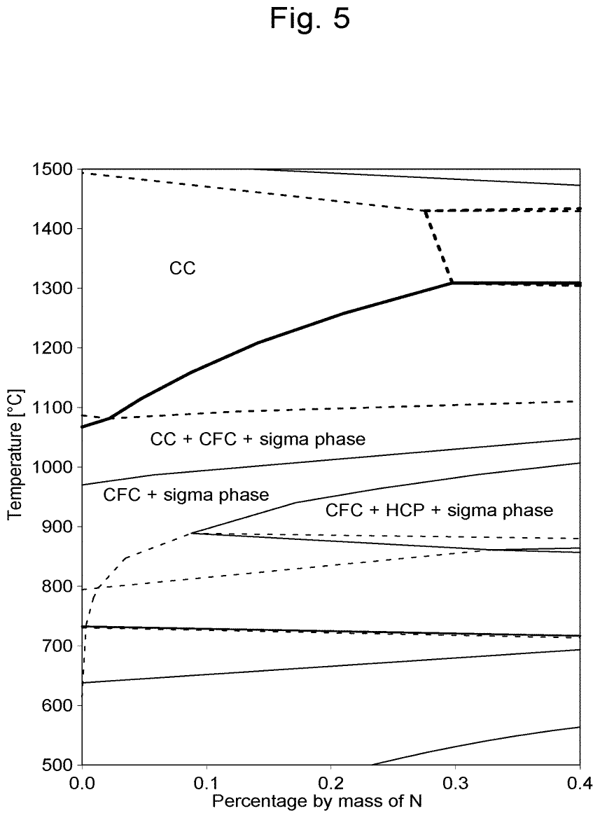

Furthermore, carrying out the heat treatment at a higher temperature reduces the risk of carbide or nitride formation which reduces corrosion resistance. More specifically, the higher the temperature, the greater the solubility of carbon and nitrogen in the austenite. This effect is illustrated for carbon using the phase diagrams in FIGS. 3 and 4 respectively for an Fe-(29.5-x)%Cr-7%Ni-3%Mo-x%C alloy according to the prior art and an Fe-(27.5-x)%Cr-7%Ni-5%Mo-x%C alloy according to the invention. By increasing the Mo concentration above 3% so that the hardening heat treatment can be carried out in the temperature range 925-1,000° C., alloys with a lower purity as regards interstitial elements such as carbon and nitrogen can be used, thus drastically reducing the cost of the alloy. Thus, with 3% molybdenum for the Fe-(29.5-x)%Cr-7%Ni-3%Mo-x%C alloy in FIG. 3, the γ+σ range is stable up to a maximum of 925° C., with the maximum carbon concentration to prevent carbide precipitation (M23C6 phase in FIG. 3) being just over 0.01% at this temperature (see arrows in the diagram). However, with 5% molybdenum for the Fe-(27.5-x)%Cr-7%Ni-5%Mo-x%C alloy in FIG. 4, the absence of carbides (M23C6 phase in FIG. 4) is guaranteed up to a maximum carbon mass concentration of almost 0.02% at a temperature of 975° C., which is still in the γ+σ (CFC+Sigma) range. This small difference of 50° C. during the hardening heat treatment, made possible by the higher Mo concentration, results in a difference in the solubility of carbon in the austenite of a factor of 2. The effect of temperature is similar for nitrogen as shown in FIG. 5 for an Fe-(27.5-x)%Cr-7%Ni-5%Mo-x%N alloy. More specifically, the maximum nitrogen concentration to prevent any nitride formation (HCP phase in FIG. 5) increases strongly with temperature, from 0.15% by mass at 925° C. to about 0.3% by mass at 975° C.

The stainless steel part according to the invention is produced using the manufacturing method described in more detail hereinbelow. According to the invention, the method for manufacturing a stainless steel part includes a step a) of providing or producing a blank having a composition that falls within the aforementioned ranges. This blank has a predominantly ferritic or, preferably, a 100% ferritic structure. The blank is obtained from a base material subjected to a heat or thermomechanical treatment at a temperature in the range of 1,000° C.-1,500° C. followed by quenching. The base material can be in a powder form or in the form of a consolidated material. It can be produced by casting, pressing, metal injection moulding (MIM), additive manufacturing, and more broadly by powder metallurgy. The base material and the heat treatment can conceivably be carried out in a single step, for example, by a selective laser melting (SLM) technique. These different techniques allow a blank to be produced with a base material having dimensions that are substantially equal to those of the part to be produced, in which case a subsequent forming step is not required.

The composition of the base material is optimised so as to obtain a predominantly or completely ferritic structure when being held at a temperature of between 1,000° C. and 1,500° C. for a duration of between 1 minute and 24 hours. The temperature is chosen so as to obtain a mass fraction of austenite of less than or equal to 40% and a mass fraction of ferrite of greater than or equal to 60%. The austenite formed when being held between 1,000° C. and 1,500° C. is referred to as primary austenite as opposed to secondary austenite formed during the subsequent hardening heat treatment. Preferably, the structure is entirely ferritic after being held between 1,000° C. and 1,500° C.

The heat or thermomechanical treatment in the range of 1,000° C.-1,500° C. can be used to carry out homogenisation, recrystallisation or stress relieving treatments on base materials obtained by casting or to carry out sintering on base materials in powder form. The treatment in the ferritic or ferritic-austenitic range can be carried out in a single cycle or can involve a plurality of heat or thermomechanical treatment cycles. It can also be preceded or followed by other heat or thermomechanical treatments.

After being held in the ferritic or ferritic-austenitic range, the blank is subjected to rapid cooling, also known as quenching, to a temperature of less than 500° C. in order to prevent the formation of new phases during cooling. Thus, the ferritic or ferritic-austenitic structure is preserved at ambient temperature. Thanks to the compositions according to the invention, the ferritic structure is sufficiently stable to be kept at ambient temperature after rapid cooling but sufficiently metastable to be easily and rapidly transformed into the sigma phase and into austenite on subsequent heat treatment at intermediate temperatures of between 600° C. and 1,000° C. (see step c) below).

At the end of step a), the alloy has a low hardness and high ductility, which can allow easy forming, for example by forging, blanking or machining.

After step a), the method includes an optional step b) of forming the blank by machining, blanking or any operation involving deformation such as forging. This step can be carried out in several sequences. This step is not required if the blank at the end of step a) already has the final shape of the part to be manufactured.

In addition to shaping, a plastic deformation operation can be implemented in particular to increase the ferrite transformation rate in the subsequent step of transforming the ferrite into austenite and into sigma phase. Moreover, as the hardening by strain hardening is low for ferritic structures and the alloy according to the invention is predominantly or completely ferritic before the hardening treatment, this plastic deformation step does not cause any hardening that could be problematic for an optional forming operation by machining or blanking. This plastic deformation in one or more sequences can be carried out at a temperature below 650° C.

After the optional forming operation, the method includes a step c) of carrying out a hardening heat treatment on the blank in one or more stages between 600° C. and 1,000° C. to obtain the final properties. The duration of the heat treatment between 600° C. and 1,000° C. is set so as to guarantee complete transformation of the ferrite and thus obtain a microstructure formed by a sigma phase and an austenitic phase. Total transformation is understood to mean a transformation of more than 99% of the ferrite into an austenitic phase+a sigma phase. Thus, the final structure could contain traces of residual ferrite at a percentage lower than 1%. The rate of transformation of the ferrite into an austenitic phase+a sigma phase depends in particular on the composition of the alloy and the thermomechanical history thereof, as mentioned hereinabove. Generally speaking, the total duration of the heat treatment in one or more stages is between 30 minutes and 24 hours. Advantageously, the heat treatment is carried out in two stages with a first stage between 600° C. and 850° C. and a second stage between 850° C. and 1,000° C. The first stage at a lower temperature procures a faster transformation rate and a finer microstructure, whereas the second stage at a higher temperature maximises resistance to corrosion. As transformation is complete after the first stage, the microstructure remains fine even after the second stage at a higher temperature.

After this hardening treatment, the steel has a mass fraction of sigma phase of between 40% and 80% and a mass fraction of austenite of between 20% and 60%, the percentages depending on the chemical composition and the heat treatments carried out. As mentioned hereinabove, the steel can contain traces of residual ferrite at a percentage of less than 1% by weight. The austenitic phase consists of secondary austenite and potentially primary austenite.

Advantageously, the primary austenite and secondary austenite have a size of less than 10 μm and more advantageously less than 5 μm. The size is understood to mean the smallest dimension of the phase in a cross-sectional view. This can be the thickness of the austenite lamellae when the austenite is in lamellar form or the diameter when the austenite is in globular form. In the latter case, when the austenite is not perfectly spherical, the size relates to the smallest dimension of the austenitic structure.

Advantageously, the final structure is formed of secondary austenite and the sigma phase without primary austenite. The resulting microstructure is a very fine and homogeneous eutectoid microstructure formed from the secondary austenite and the sigma phase. Secondary austenite has the characteristic of being finer than primary austenite. This coarser structure of the austenite formed before hardening is less conducive to a mirror finish. Moreover, the differences in composition between the austenites formed before and after the hardening treatment respectively are less favourable in terms of corrosion resistance.

The part obtained has a high hardness of between 575 and 900 HV10, and more specifically between 650 and 900 HV10, thanks to the hardening heat treatment. As with all stainless steels, possible non-metallic inclusions can also be present in small quantities, without affecting the mechanical and magnetic properties. Moreover, machinability-enhancing inclusions, such as manganese sulphides, can also be present in small quantities in the alloy.

This hardening heat treatment step can be followed by an optional surface finishing step d) such as polishing.

Alternatively, in the presence of a blank with an austenite+ferrite structure in step a), the manufacturing method can include an additional step b′), prior to the hardening heat treatment, in the temperature range 100° C.-1,500° C. to transform the austenite +ferrite structure into a 100% ferritic structure.

To summarise, after the high-temperature heat treatment (1,000° C.-1,500° C.) followed by quenching, the steels have in particular the following properties:
A hardness of between 150 and 400 HV10.
Good ductility with a plastic deformation without cracking of greater than 50% in compression at ambient temperature.
A ferromagnetic behaviour, due to the presence of ferrite.

After the hardening heat treatment, the steels according to the invention have in particular the following properties:
A hardness of between 575 and 900 HV10.
A paramagnetic behaviour.
Excellent polishability, thanks to the very fine microstructure.
Very high resistance to wear.
High resistance to corrosion.

With regard to corrosion resistance, the steel according to the invention is particularly effective thanks to the molybdenum concentration of more than 3%, which increases the corrosion resistance of the austenitic phase and thus of the alloy as a whole. These steels are thus of particular interest for external components.

Finally, the invention is illustrated by way of the following examples.

### EXAMPLES

### Example 1

The steel known as Fe29Cr8Ni5Mo contains 58% iron, 29% chromium, 8% nickel and 5% molybdenum by mass. It was manufactured by arc melting from high-purity elements (>99.9%) and cast in the form of a bar. It was then subjected to a homogenisation heat treatment at 1,300° C. for 2 hours in an argon atmosphere followed by gas quenching (about 200 K/min). The bar was then deformed at ambient temperature by compression with a reduction in thickness by a factor of 2 before being annealed in the ferritic range at 1,080° C. for 10 minutes in air and quenched in water. In the annealed temper, the Fe29Cr8Ni5Mo alloy has a Vickers hardness of 265 HV10. A hardening heat treatment was subsequently carried out on one sample at 850° C. and on another at 900° C. for 6 hours. A fine, homogeneous, two-phase microstructure comprising the austenitic phase and the sigma phase is obtained. In this temper, the Fe29Cr8Ni5Mo alloy has a Vickers hardness of 705 and 675 HV10 respectively.

### Example 2

The steel known as Fe29Cr7Ni4Mo contains 60% iron, 29% chromium, 7% nickel and 4% molybdenum by mass. It was also manufactured by arc melting from high-purity elements (>99.9%), subjected to a homogenisation heat treatment at 1,300° C. for 2 hours in argon followed by gas quenching, deformed at ambient temperature by compression with a reduction in thickness by a factor of 2, and subjected to an annealing heat treatment at 1,100° C. in air for 10 minutes followed by water quenching. After this annealing heat treatment, the Fe29Cr7Ni4Mo alloy has a single-phase ferritic microstructure. A first sample was then heated to 700° C. for 4 hours and then to 900° C. for 3 hours under a vacuum. The hardness obtained is 670 HV10.

A second sample was heated to 750° C. for 7 hours under a vacuum. The hardness obtained is 735 HV10. In both cases, a fine two-phase microstructure is obtained.

### Example 3

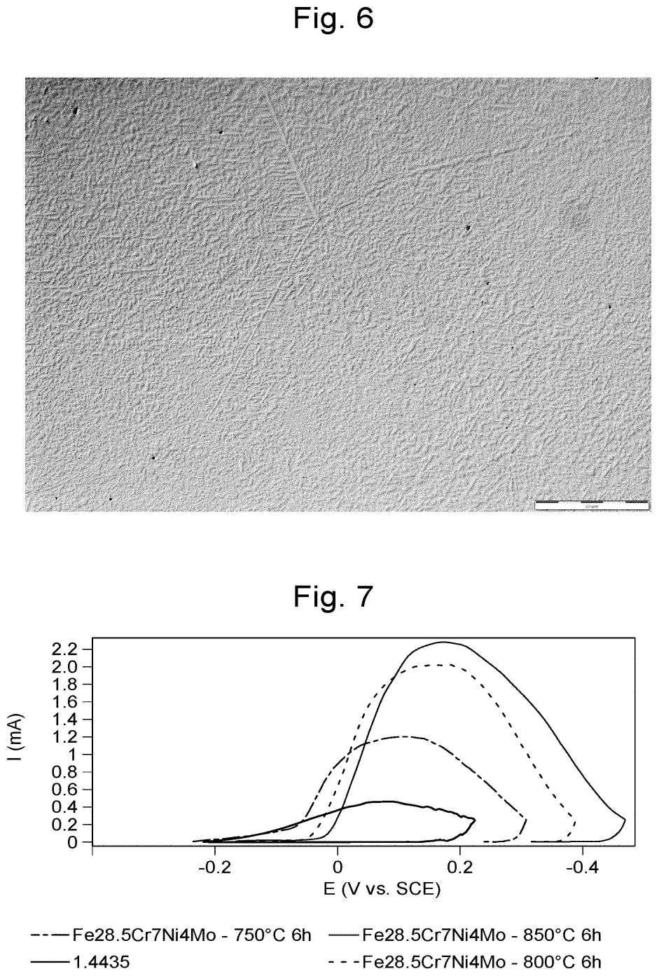

The steel known as Fe29.5Cr7Ni3.5Mo contains 60% iron, 29.5% chromium, 7% nickel and 3.5% molybdenum by mass. It was also manufactured by arc melting from high-purity elements (>99.9%), subjected to a homogenisation heat treatment at 1,300° C. for 2 hours in argon followed by gas quenching, deformed at ambient temperature by compression with a reduction in thickness by a factor of 2, and subjected to an annealing heat treatment at 1,100° C. in air for 15 minutes followed by water quenching. After this annealing heat treatment, the Fe29.5Cr7Ni3.5Mo alloy has a single-phase ferritic microstructure. A first sample was then heated to 700° C. for 4 hours and then to 900° C. for 3 hours under a vacuum. The hardness obtained is 675 HV10. A second sample was heated to 750° C. for 7 hours under a vacuum. The hardness obtained is 730 HV10. The microstructure observed by optical microscopy in polarised light is shown in FIG. 6 for the first sample. A fine distribution of the two phases can be observed, with the austenitic phase predominantly in the form of lamellae being raised and the sigma phase in array form.

### Example 4

In order to evaluate the resistance to corrosion in a chloride medium and in particular the resistance to pitting, potentiodynamic polarisation tests were carried out on a commercial reference stainless steel, namely DIN 1.4435 steel, and on an Fe28.5Cr7Ni4Mo grade according to the invention, which was subjected to a hardening heat treatment at three different temperatures, i.e. 750, 800 and 850° C. respectively for 6 hours in a vacuum. Beforehand, the steels were heat treated at 1,300° C. for 2 hours in argon and then cooled by gas quenching to obtain a 100% ferritic structure at ambient temperature. After heat treatment at 750, 800 or 850° C., the alloys have a two-phase austenite+sigma phase structure. The potentiodynamic polarisation measurements were carried out in an electrochemical cell comprising a calomel reference electrode saturated with potassium chloride and a platinum auxiliary electrode. The sample to be analysed, i.e. the work electrode, is in the form of a disc measuring 8 mm in diameter with a mirror finish. The potentiodynamic polarisation tests are used to assess corrosion resistance in a chloride medium by comparing pitting potentials. The latter correspond to the potentials for which a rapid increase in current is measured as a result of local breakdown of the passive film and pitting corrosion. For the purpose of the tests, the pitting potential is defined as the potential corresponding to a current of 0.25 mA. Firstly, a 1 M NaCl solution is prepared, introduced into the cell and then nitrogen-purged for 1 hour. The free potential Voc of the work electrode is recorded for 10 minutes. The potential from the last free potential value is then increased at a rate of 0.5 mV/s to a measured current of 0.25 mA, and then the potential is decreased at a rate of 2 mV/s to a measured current of 0.01 mA. The results are shown in FIG. 7. It can be clearly seen that the pitting potential increases as the heat treatment temperature increases, with values of 0.32, 0.38 and 0.46 V vs SCE for the heat treatment at 750, 800 or 850° C. respectively and 0.24 V vs SCE for the reference austenitic stainless steel. Moreover, repassivation in the potential reduction phase is facilitated when the heat treatment temperature is high. This illustrates the benefit of increasing the Mo content to increase the heat treatment temperature and thus resistance to corrosion.

1. Paramagnetic A paramagnetic stainless steel with a chemical composition comprising iron and, by weight:
25≤Cr≤35%,
5≤Ni≤10%,
0≤Mn≤3%,
0≤Al≤3%,
0≤Cu≤2%,
0≤Si≤5%,
0≤Ti≤1%,
0≤Nb≤1%,
0≤C≤0.1%,
0≤N≤0.5%,
0≤S≤0.5%,
0≤P≤0.1%,
optionally, any impurities, each at a concentration of less than or equal to 0.5%,
wherein the paramagnetic steel has a hardness in a range of from 575 to and 900 HV10.

2. The steel of claim 1, wherein the Mo is greater than or equal to 3.5%.

3. The steel of claim 1, wherein the Mo is in a range of from 3.5 to 6%.

4. The steel of claim 1, wherein the Mo is is in a range of from 4 to 6%.

5. The steel of claim 1, wherein the W is greater than or equal to 0.2%.

6. The steel of claim 1, wherein the W is greater than or equal to 0.5%.

7. The steel of claim 1, wherein the hardness is in a range of from 650 to 900 HV10

8. The steel of claim 1, wherein the hardness is in a range of from 675 to 900 HV10.

9. The steel of claim 1, having a microstructure formed by
a sigma phase in a range of from 40 to 80 wt. %, and
an austenitic phase in a range of from 20 to 60 wt. %.

10. The steel of claim 9, wherein the austenitic phase comprises primary austenite and secondary austenite originating from a transformation of an alloy having a structure comprising ferrite and austenite.

11. The steel of claim 9, wherein the austenitic phase comprises secondary austenite,
wherein the secondary austenite originates from transformation of an alloy having a 100% ferritic structure. wherein the austenitic phase has a size of less than 10 μm,
wherein the size is a smallest dimension of the austenitic phase in a cross-sectional view.

13. The steel of claim 12, wherein the austenitic phase has a size of less than 5 μm.

14. A part, comprising:
the steel of claim 1.

15. The part of claim 14, which is a timepiece component of an external part or movement.

16. A watch, comprising:
the timepiece component of claim 15.

17. A method for manufacturing a part including paramagnetic stainless steel, method comprising:
heat treating, as a hardening, a blank having the having a chemical composition of the paramagnetic stainless steel of claim 1 to obtain a part, the hardening being carried out in one or more stages at a temperature in a range of from 600 to 1,000° C. for a total duration in a range of from 30 minutes to 24 hours to transform a ferrite of a structure into an austenitic phase and an intermetallic sigma phase, the hardening treatment being followed by cooling to ambient temperature.

18. The method of claim 17, further comprising, prior to the hardening:
producing a predominantly or entirely ferritic structure of the blank by carrying out a heat or thermomechanical treatment (a) on a base material at a temperature in a range of from 1,000 to 1,500° C. for a duration of in a range of from 1 minute to 24 hours,
wherein the heat or thermomechanical treatment (a) is followed by quenching to a temperature of less than 500° C. to preserve the ferritic structure at ambient temperature.

19. The method of claim 17, wherein the hardening is carried out in two stages with a first stage in a range of from 600 to 850° C. and a second stage in a range of from 850 to 1,000° C.

20. The method of claim 18, wherein the base material is in a powder form or in the form of a consolidated material.

21. The method of claim 18, wherein the base material was obtained by casting, pressing, metal injection molding, additive manufacturing, or powder metallurgy.

22. The method of claim 21, the blank is made by selective laser melting.

23. The method of claim 17, wherein, prior to the hardening, the structure of the blank comprises a mass fraction of austenite of less than or equal to 40% and a mass fraction of ferrite of greater than or equal to 60%.

24. The method of claim 17, wherein, prior to the hardening, the structure of the blank comprises 100% ferrite.

25. The method of claim 17, wherein, prior to the hardening, the blank has a hardness in a range of from 150 to 400 HV10.

26. The method of claim 17, further comprising, prior to the hardening:
forming the blank, having a different shape than that of the part to be manufactured, comprising a plastic deformation sequence at a temperature of less than 650° C.

27. The method of claim 17, further comprising, prior to the hardening:
forming the blank, having a different shape than that of the part to be manufactured, by forging, blanking, or machining.

28. The method of claim 18, wherein the heat or thermomechanical treatment (a) is carried out in several cycles.

29. The method of claim 23, further comprising, if the structure of the blank comprises the austenite, prior to the hardening:
carrying out a heat or thermomechanical treatment (b) on the blank at a temperature in a range of from 1,000 to 1,500° C. for a duration in a range of from 1 minute to 24 hours, to obtain an entirely ferritic structure,
wherein the heat or thermomechanical treatment (b) is followed by quenching to a temperature of less than 500° C. to preserve the entirely ferritic structure at ambient temperature.
